(19) United States
(12) Patent Application Publication
(10) Pub. No.: US 2002/0046041 A1
(43) Pub. Date: Apr. 18, 2002

(54) Automated reputation/trust service

(76) Inventor: Ken Lang, Wellesley, MA (US)

Correspondence Address: LAHIVE & COCKFIELD, 28 STATE STREET, BOSTON, MA, 02109, US

(21) Appl. No.: 09/852,861

(22) Filed: May 10, 2001

Related U.S. Application Data
(60) Provisional application No. 60/213,638, filed on Jun. 23, 2000.

(51) Int. Cl. G06F 17/60; G06F 7/00; G06F 17/00

(52) U.S. Cl. 705/1; 705/26; 707/104.1

(57) ABSTRACT

A reputation/trust service provides reputation information to requesting clients. The reputation/trust service may obtain remuneration in response to providing the reputation data. The reputation/trust service may be automated and may support on-line access via a network, such as a computer network or a telecommunications network. The reputation/trust service is especially well adapted for use on the Internet. The reputation/trust service may provide reputation information for various types of parties, including but not limited to persons, groups of persons, organizations and companies. Reputation data may be held for multiple traits of any given party. Reputation data may be updated and validated on an ongoing basis.

### RELATED APPLICATIONS

This application claims the benefit of priority under 35 U.S.C. 119(e) to co-pending U.S. provisional application Ser. No. 60/213,638, filed Jun. 23, 2000, the entire contents of which are hereby incorporated by reference.

### TECHNICAL FIELD

The present invention relates generally to information processing and more particularly to an automated service for providing reputation and trust information.

### BACKGROUND OF THE INVENTION

During everyday activities, a person relies upon the reputation of another party in many situations. For example, in picking a doctor, a person typically attempts to ascertain the reputation of the doctor and selects a doctor that has a reputation for being competent and friendly. Similarly, in conducting business transactions, a person generally seeks to conduct business transactions with parties that are trustworthy and reliable.

One difficulty that has arisen with the growth of the Internet is the lack of ability to determine the reputation of parties that are accessible via the Internet. For example, when a person wishes to purchase an item from a website, the person has no information regarding the authenticity of this website, the reputation for quality service provided by the website, etc. The lack of reputation/trust information in conventional systems has also prevented the development of new applications that exploit the true power of the Internet to readily interconnect large numbers of parties for activities that rely, at least in part, on reputation.

### SUMMARY OF THE INVENTION

The above-described limitations of conventional systems are overcome by the automated reputation/trust service of the present invention. The reputation/trust service enables reputation information to be accessible on-line via a computer or telecommunications network. The reputation/trust service may be accessible via the Internet. Clients may be assessed a charge and may be required to provide remuneration for obtaining reputation information.

The reputation information provided by the automated reputation/trust service may contain data for multiple parties. In addition for any given party, data may be stored for the party's reputation regarding multiple traits. In some embodiments, the data may be stored within one or more databases. Parties may include a person, groups of people, companies, organizations and other entities.

In accordance with one aspect of the present invention, an automated reputation service is provided for furnishing information regarding reputations and parties relative to multiple traits. The client is provided with access to the reputation service via a communications network to furnish the information regarding a reputation of the selected party relative to a given trait.

In accordance with another aspect of the present invention, selection of reputation data is provided regarding at least one selected party. At least a portion of the reputation data is provided to a client, and remuneration is accepted on behalf of the client for furnishing the portion of reputation data to the client.

In accordance with an additional aspect of the present invention, a system includes a collection of reputation data regarding multiple parties. The system also includes an automated reputation service for accessing the collection of reputation data on behalf of clients to provide the clients with data from the collection of reputation data.

### BRIEF DESCRIPTION OF THE DRAWINGS

An illustrative embodiment of the present invention which will be described below relative to the following drawings.

FIG. 1 depicts data flow between the reputation service of the illustrative embodiment and multiple clients.

FIG. 2 is a block diagram depicting an environment that is suitable for practicing the illustrative embodiment.

FIG. 3 depicts an example of reputation information that maybe stored for a party in the illustrative embodiment.

FIGS. 4A, 4B and 4C illustrate examples of fields that may be stored for a given reputation.

FIG. 5 shows an exemplary set of database tables for accessing reputation information.

FIG. 6 is a block diagram illustrating data flow from client to database to obtain reputation information.

FIG. 7 is a flow chart illustrating steps that are performed in the illustrative embodiment to access reputation information for a requestor.

FIG. 8 is a diagram illustrating possible charging options for charging a client for accessing reputation information regarding a party.

FIG. 9 illustrates another example of an environment that is suitable for practicing the illustrative embodiment of the present invention.

FIG. 10 is a flowchart illustrating the steps that are performed in updating reputation information stored within a database in the illustrative embodiment.

FIGS. 11A, 11B and 11C show examples of screens that are presented to a user when the user seeks to obtain reputation information regarding a party from the reputation service.

### DETAILED DESCRIPTION OF THE INVENTION

The illustrative embodiment of the present invention provides a reputation service that may furnish reputation/trust information to requesting parties. In the illustrative embodiment, the reputation service may be generalized so as to hold information regarding the reputation of a party as to multiple traits or characteristics. A party may have multiple reputations corresponding to multiple traits. The parties need not be limited to persons but rather may include persons, groups of persons, organizations, corporations, automated agents for persons and the like. The reputation service may seek remuneration for providing information regarding reputations to requesting clients. Remuneration may take many forms including monetary remuneration.

The information stored by the reputation service for any given party may be updated so as to keep the information current. Safeguards may be provided for ensuring that the information upon which a reputation is based is valid and reliable. Access to certain reputation information via the reputation service may be restricted so that only authorized persons can access the reputation information.

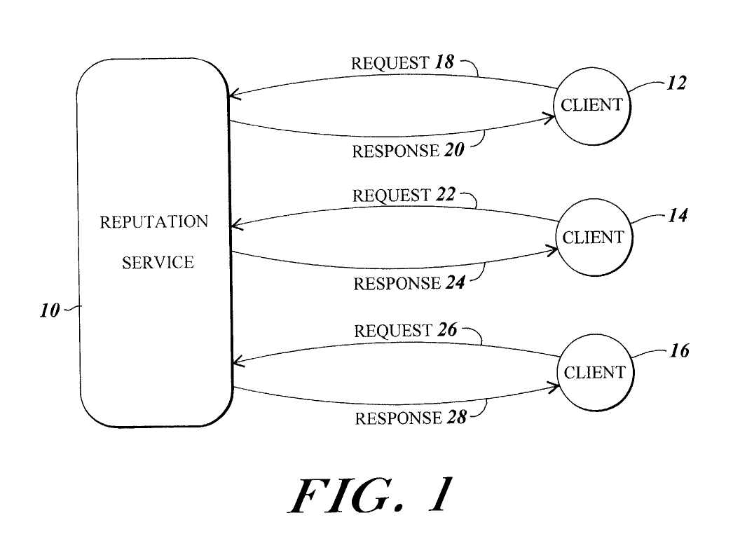

FIG. 1 depicts the basic relationship between the reputation service 10 and clients 12, 14, 16 in the illustrative embodiment. Client 12 submits a request 18 to the reputation service and receives back a response 20. The response 20 may take many forms. For example, the response 20 may be an email containing the requested reputation information. Alternatively, a hard copy of the requested reputation information may be sent via conventional mail or courier service to the client 12. Still further, the response 20 may take the form of an electronic communication other than an email message. The client 12 may be a programmatic entity (such as a computer program) that is capable of taking the electronic communication (constituting the response 20) and extracting the information that it needs. For security purposes, the response 20 may be encrypted or may include encrypted information. Digital signatures and other information may be affixed to the response 20 to prevent fraudulent communication of reputation information. Clients 14 and 16 follow the same interaction pattern of submitting respective requests 22 and 26 and receiving respect from responses 24 and 28.

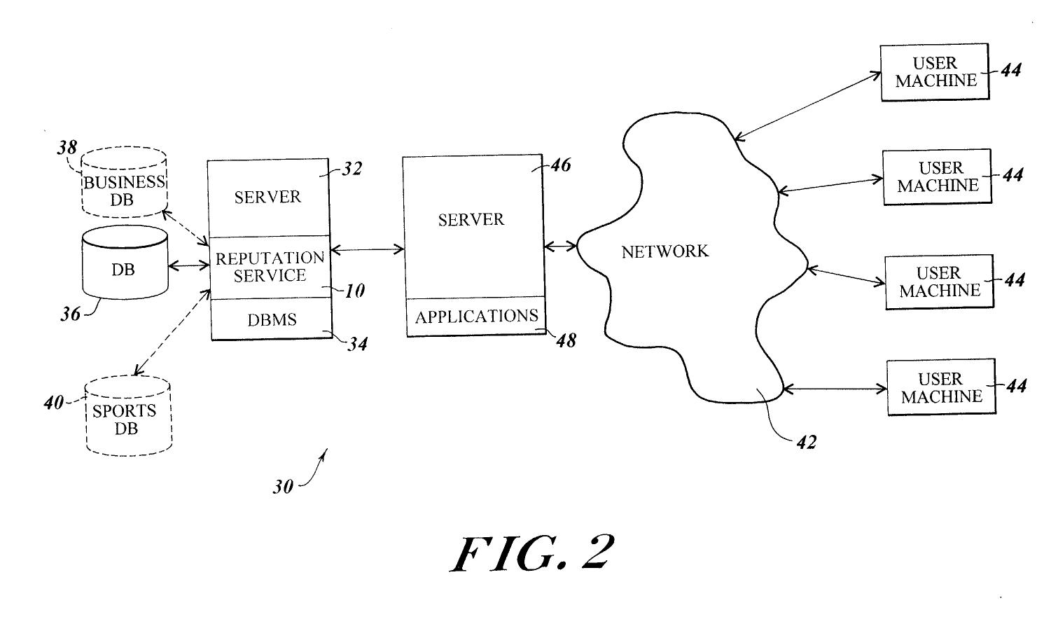

FIG. 2 depicts a block diagram of an environment 30 that is suitable for practicing the illustrative embodiment. Those skilled in the art will appreciate that the depiction in FIG. 2 is intended to be merely illustrative and not limiting of the present invention. For example, the reputation information need not be stored in a database, but rather may be stored in flat files or in a format other than a “database.” Moreover, the parties that use the reputation service need not access the reputation service via a network; rather they may have a hardwired connection to the reputation service. Furthermore, the configuration may include different numbers of servers, user machines and networks.

The environment 30 depicted in FIG. 2 includes a reputation service 10 that is automated and implemented, at least in part, by computer program instructions. One suitable implementation is to implement the reputation service via a computer program or suite of computer programs. Nevertheless, those skilled in the art will appreciate that in alternative implementations the reputation may, at least in part, be implemented by firmware or hardware. In FIG. 2, the reputation service 10 is shown being executed on a server 32. This server may take many forms including that of a dedicated server computer system, a workstation, a person computer system, a mainframe computer system, or another variety of suitable electronic device. It is presumed that a database management system (DBMS) is executing on server 32 to manage access to the database 36. The database 36 holds reputation information that the client seeks to access from the reputation service 10.

Those skilled in the art will appreciate that the present invention may have more than a single database 36. Some embodiment may employ multiple databases for holding the reputation information. In the example depicted in FIG. 2, a business database 38 and a sports database 40 the are shown in phantom form to hold reputation information relating to business and sports, respectively. These additional databases 38 and 40 may work in conjunction with database 36. Those skilled in the art will appreciate that the multiple databases may, instead of being split along data content lines, be partitioned along different logical partitions.

Server 32 may be in communication with another server 46 that runs application programs 48. For example, the server 46 may be a web server that runs applications 48 that require access to the reputation service 10. The server 46 may support a website that access the reputation service 10. Server 46 need not be directly coupled to server 32 but rather in some instances may be accessible to server 32 via a network 42. The network 42 may be a computer network, such as a local area network (LAN) or a wide area network (WAN). The network 42 may be a computer network such as the Internet, an intranet, an extranet or another variety of computer network. The network 42 may also include a communications network, such as a telephone network, including a public switched telephone network (PSTN) or a private telephone network. The network 42 may, in some instances, be a hybrid of both computer networks and telephone networks. The network 42 may include wireless networks where wireless communication paths are used. User machines 44 are connected to the network 42 and may gain access to services provided by the server 46 and the server 32.

In order to clarify the discussion below, it is helpful to define a few terms. The term “reputation” refers to the general estimation in which a person or thing is held by the public or other group. A reputation may be specific to a character or trait that is ascribed to the person or thing. The term “trust” refers to a firm reliance on the integrity, ability or character of a person or thing. Alternatively, “trust” refers to a confident belief. For purposes of the illustrative embodiment, trust is used in two fashions. First, a party may have a reputation as to trustworthiness. Second, a client may need to know the extent to which a given reputation is trustworthy or not.

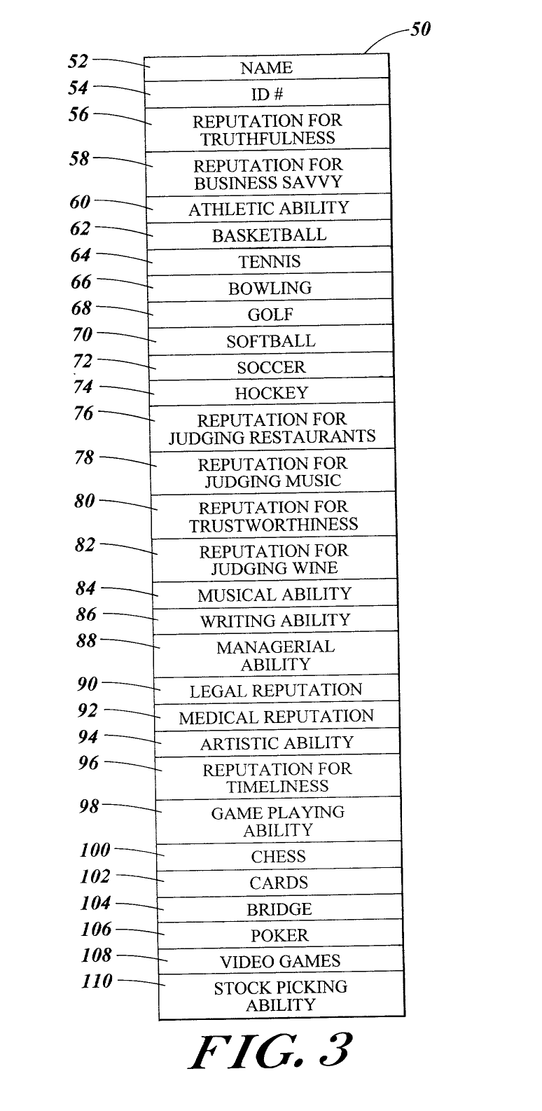

FIG. 3 depicts an example of reputation information that may be stored by the reputation service 10 for a given party in the illustrative embodiment. The reputation information 50 depicted in FIG. 3 includes a name field 52 to identify the name of the party as well as an identification number (ID #) 54 that uniquely identifies the party amongst the parties for which reputation data is held by the reputation service 10. The ID #54 helps to distinguish cases where parties have the same name. Information regarding the reputation for truthfulness 56 of the party is stored. This information may identify whether the party is generally truthful or is generally not truthful. The reputation information 50 also includes information regarding a reputation for the business savvy 58 of the party. Such information may be used by recruiters, competitors and other individuals, for instance.

The reputation information 50 includes information regarding the reputed athletic ability 60 of the given party. General reputation information of athletic ability may be stored as well as information regarding particular sports. For example, reputation information regarding basketball ability 62, tennis ability 64, bowling ability 66, golf ability 68, softball ability 70, soccer ability 72 and hockey ability 74 are stored for the party in FIG. 3. More generally, information regarding reputed abilities may be stored within the database 36 for individuals, as well as teams, leagues, etc.

The reputation information 50 may also include a party's reputation for accurately judging things. For example, the reputation information 50 of FIG. 3 includes information regarding the party's reputation for judging restaurants 76 and information regarding the party's reputation for judging music 78. Individuals with excellent reputations for judging restaurants may have the ability to financially exploit, such an ability via a computer network, by holding themselves out as on-line restaurant critics. Individuals with an excellent reputation for judging music may have opportunities to act as record critics or talent scouts. Along a similar vane, the reputation information 50 includes information regarding a reputation for judging wine 82. When a restaurant wishes to hire a sommelier, the restaurant may, for example, access the reputation service 10 to obtain the reputation for judging wine of applicants for the position.

Information regarding reputation for trustworthiness of a party 80 may be held in the database 36.

Reputation information regarding ability need not be limited to sports but may also be applicable to other activities. As a result, the reputation of information 50 may hold reputation for musical ability 84, reputation for writing ability, reputation for manageability 88. The reputation information 50 may include information regarding game playing ability 98. This reputation information may be broken down by particular categories of games, such as information regarding chess playing ability 100 and information regarding card playing ability 102. Card playing ability may be further broken down into information regarding bridge-playing ability 104 and information regarding poker-playing ability 106, for example. The reputation information 50 may also hold information regarding video game playing ability 108.

Some reputation information has applicability to businesses. For example, lawyers may have a legal reputation that serves as a basis for them attaining business. As a result, the reputation information 50 may include information regarding legal reputation 92, information regarding medical reputation 92, information regarding artistic ability 94 and information regarding timeliness 96. The reputation information 50 may hold information such as reputation regarding stock picking ability 110. This information may have particular value to financial advisors, investment houses and the like.

Those skilled in the art will appreciate that the depiction of reputation information 50 in FIG. 3 is intended to be merely illustrative and limiting of the present invention. Reputation information 50 need not include the fields depicted in FIG. 3. In some instances, a subset of the information depicted in FIG. 3 may be maintained. In other instances, a superset that includes the information depicted in FIG. 3 may be maintained. In still other instances, the reputation information may be entirely different from the exemplary varieties depicted in FIG. 3. In general, the reputation information maintained by the illustrative embodiment may vary depending upon the application(s) that requires reputation information.

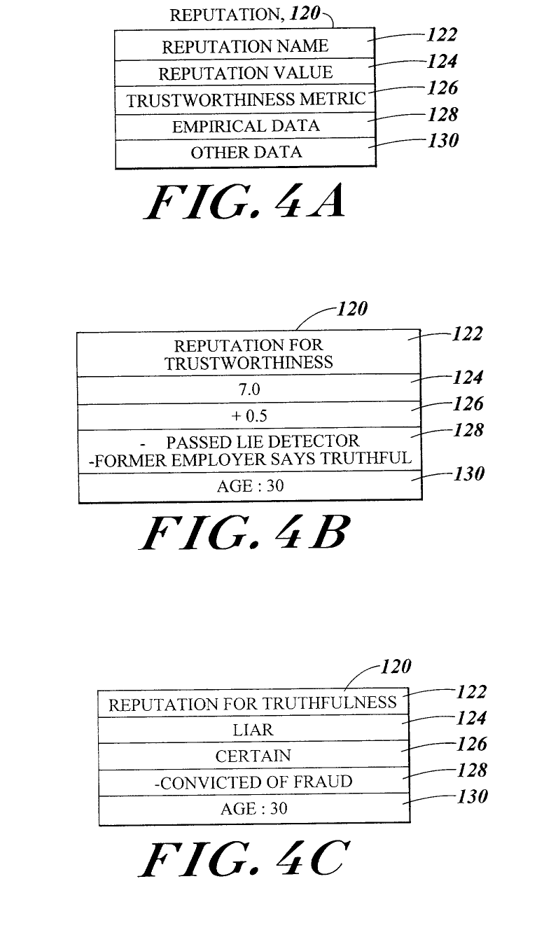

The reputation information for a particular characteristic or trait may include multiple fields or facets. As shown in FIG. 4A, a given reputation 120 (representing, for example, one of the boxes shown in FIG. 3) may hold information such as a reputation name 122, a reputation value 124 and a trustworthiness metric 126 that identifies the trustworthiness of the reputation value. Empirical data 128 justifying the reputation may also be stored along with other data 130. FIG. 4B shows an example of a reputation 120 with values in the respective fields. The example in FIG. 4B shows a reputation for truthfulness (see field 122). Parties are given a score ranging from 1-10, with 10 being the highest reputation for truthfulness and 1 being the lowest reputation for truthfulness. In the example depicted in FIG. 4B, the party has a reasonable reputation for truthfulness and is given a value of 7 on the scale ranging from 1-10. The trustworthiness metric 126 implies that the true value of the reputation of truthfulness that the party probably varies from 6.5 to 7.5 and, thus, has a variance of ±0.5. The empirical data 128 indicates that the party passed a lie detector test and that a former employer says that the party is truthful. The other data 130 indicates the age of the party.

FIG. 4C shows another variety of the same reputation 120 as depicted FIG. 4B, where the reputation value and trustworthiness metric are not numerical but rather are associated with categories or labels. In the example depicted in 4C the party has a poor reputation for truthfulness and, hence, has been assigned the “liar” category. The trustworthiness metric 126 is of the “certain” category. The empirical data 128 notes that the party has been previously convicted of fraud.

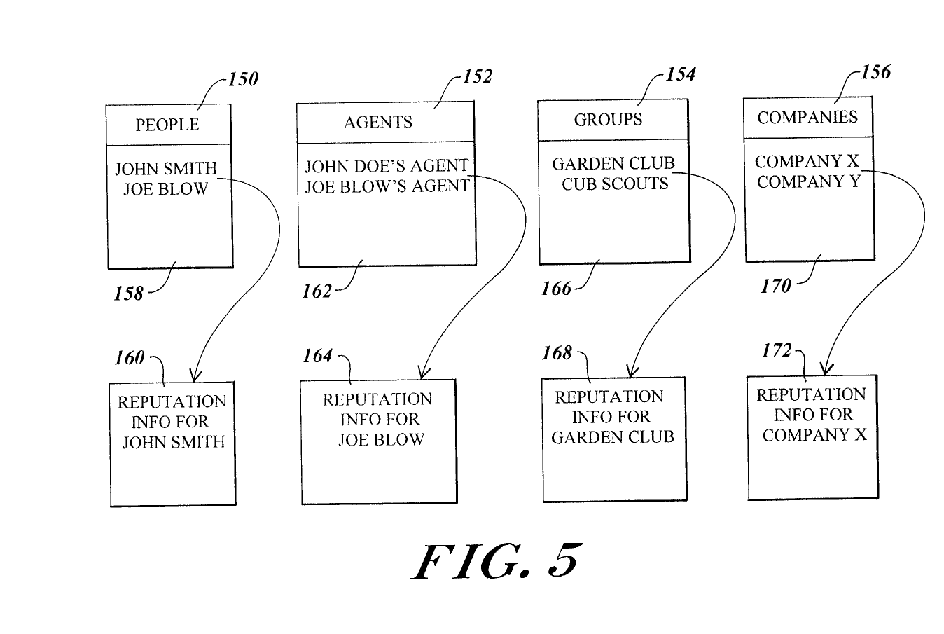

The reputation information used by the reputation service 10 may be organized in multiple fashions, including that of a database, as mentioned above. The data may be organized in a relational database where a series of tables reflect the relations between the data. As mentioned above, the parties for which reputation information is maintained may take many forms including but not limited to people, automated agents, groups and companies. FIG. 5 depicts an example of higher level tables 150, 152, 154 and 156 for use in such a relational database. The people table 150 has an entry of each of the people for whom reputation information is held. Entry 158 in the table 150 is for John Smith, and the entry includes information for accessing the information for John Smith 160. Similarly, the agents table 152 holds an entry 162 for John Doe's agent. Entry 162 may be used to gain access to the reputation information for John Doe 164. In an analogous fashion, the groups table 154 holds information for groups and includes an entry 166 for a garden club that facilitates access to reputation information for the garden club 168. Lastly, the companies table 156 holds an entry 170 for Company X that may be used to gain access to reputation information for Company X 170.

Those skilled in the art will appreciate the depiction of the database and tables in FIG. 5 is intended to merely illustrative and not limiting of the present invention. The depiction has been purposely simplified so as to not obfuscate the nature of the illustrative embodiment. Those skilled in the art will appreciate that multiple tables may be utilized and that the table depicted in FIG. 5 may not be utilized in some embodiment. Moreover, the tables may be organized into a hierarchy having additional levels that are not depicted in FIG. 5.

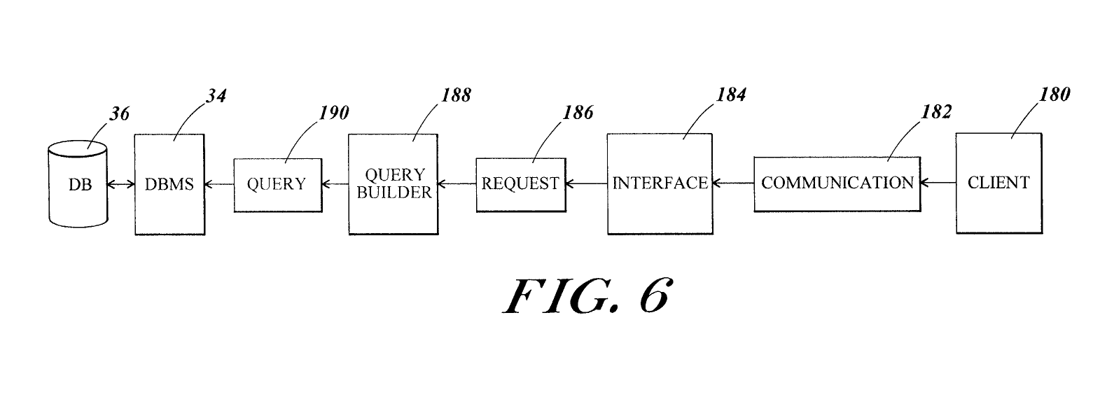

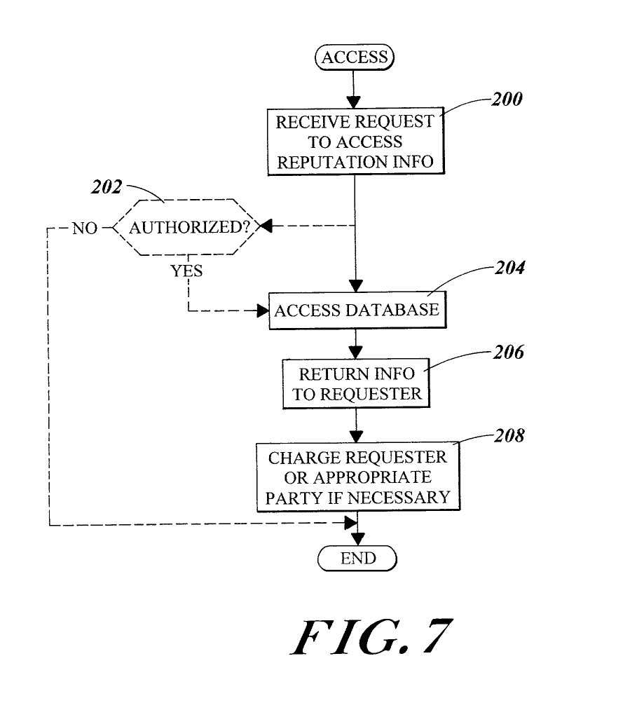

In order to appreciate the operation of the illustrative embodiment, it is helpful to review the process by which a request is forwarded to the reputation service. FIG. 6 is a block diagram illustrating the passage of information between components in the illustrative embodiment. This block diagram will be described in conjunction with the flow chart of FIG. 7. A client 180, such as a user, an application program or the like sends a communication 182 to the reputation service 10 to request reputation information regarding a party (step 200 in FIG. 7). The reputation service may include an interface 184 that facilitates communication with the client 180. This interface 184 take many forms, such as a web page or a programmatic interface, like an application program interface (API). Interface 184 receives the communication 182 and forwards the request 186 contained in the communication 182 to a query builder 188. The query builder 188 is responsible for taking the request 186 and translating the request into a query 190 that may be processed by the DBMS 34.

In some instances, it may be necessary to determine whether the requester (i.e. the client) is authorized to access the requested information (see step 202, shown in phantom form in FIG. 7). If the reputation information is particularly sensitive, only selected parties may be able to access this information. Authorization step 202 may require that the requesting that the requester provide the user ID and password in some instances. If the requestor is a program, the program may be required to perform certain handshaking or other protocols before the request is deemed to be authorized.

If the request is authorized or if no authorization is required, the database 36 is accessed by the DBMS 34 processing the query (step 204 in FIG. 7). The retrieved reputation information may then be returned to the requester (step 206 in FIG. 7). As was mentioned above, the information may be returned in multiple fashions. For example, the information may be returned in an electronic mail message or returned in a web page. Alternatively, a hard copy of the information may be returned via conventional mail or via courier service. Still further, the information may be returned via other communication media, such as via an automated voice message or the like. The information may be encrypted or stored in secured digital form so as to insure that the information reaches the appropriate party and is only modifiable by the appropriate requesting party. Still further, digital signatures or other things may be attached to the information to confirm that the reputation information is authentic.

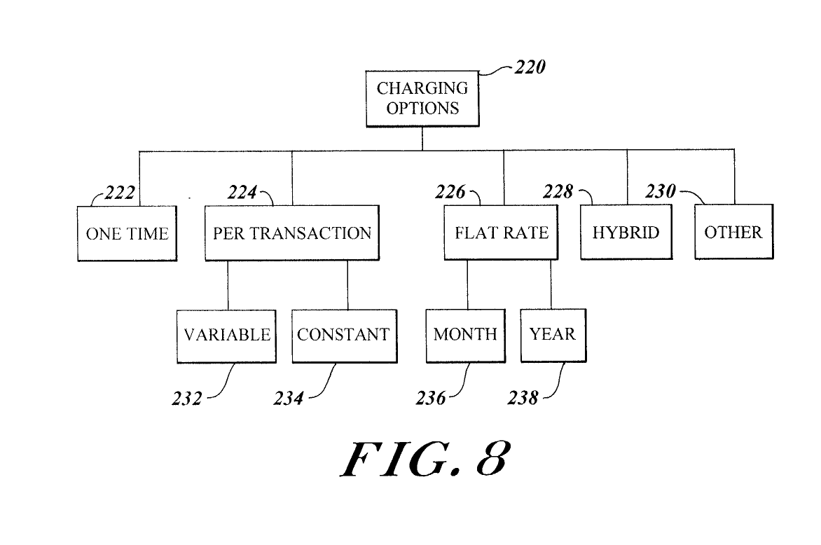

The requester or other appropriate party may be charged in some instances for obtaining the reputation information. The appropriate party in some cases may be a corporation for which the party is acting or some other beneficiary. (see step 208 in FIG. 7). As shown in FIG. 8, there are a number of different approaches to charging for information requests. FIG. 8 outlines a number of charging options 220. The depiction in FIG. 8 is not intended to be exhaustive and merely lists several options that are available. One option is that a requester is charged a one-time fee 220 and then is able to access the reputation service thereafter without charge. The reputation service and the requester may enter a contact or other arrangement to facilitate such a charging option. Another charging option is for charges to be based per transaction 224. One possible scenario is for a charge to be levied every time a request is received. The charges may be variable 230 or may be constant 234. Variable charges may vary based upon the type of reputation information requested, the time or date at which the information is requested and other factors. With a constant charge case, the requester may be levied a charge based purely on a fixed value per transaction.

Charging options may also include the charging of a flat rate fee 226 for periods of time such as a monthly period 236 or a yearly period 238. Those skilled in the art will appreciate the periods may include weeks, days, hours, minutes and the like. Charging options 220 may also include hybrids 228 that are combinations of the above-described approaches. Charging options may even include other charging scenarios 230 that have not been explicitly set forth herein.

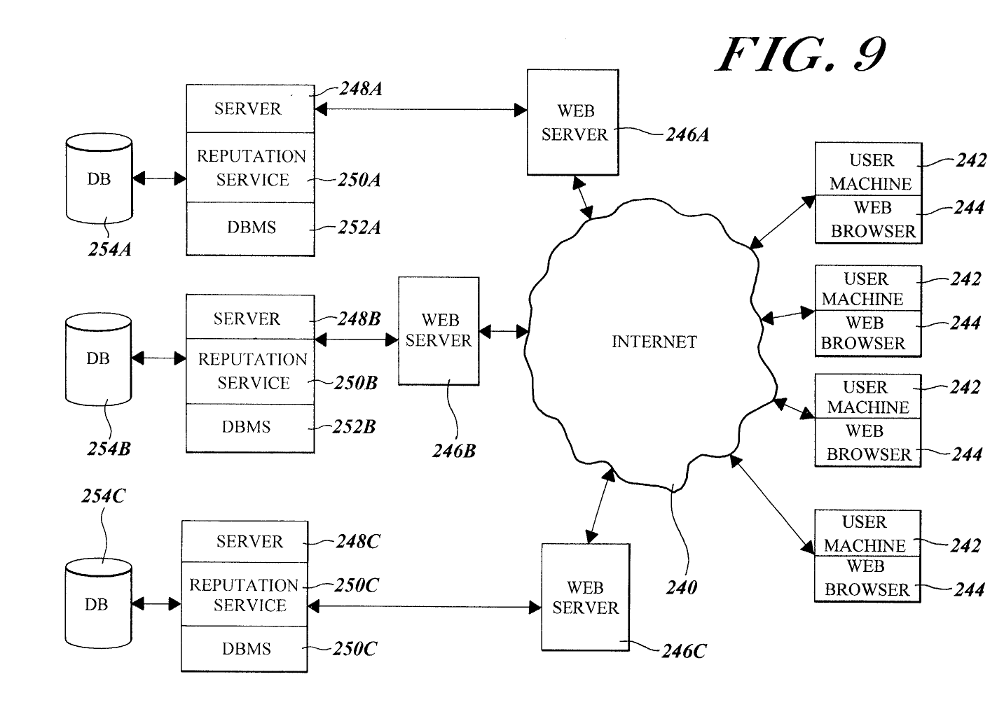

FIG. 9 shows another environment that is suitable for practicing the illustrative embodiment. In the example of FIG. 9, the network 240 is the Internet. In addition, multiple instances of the reputation service, 258, 250B and 250C are operating on separate respective servers to 248A and 248B and 248C. The servers 248A, 248B and 248C may be located at remote geographic locations. The instances of the reputation service 250A, 250B and 250C may cooperate with each other or may run independently. Separate databases 254A, 254B, and 254C may be provided for the respective reputations service instances, 250A, 250B, and 250C. In such a case, there are separate DBMS instances 252A, 252B, and 252C. This approach may be a particularly appropriate to facilitate load balancing and to reduce latencies. The servers 248A, 248B, and 248C may be accessible via respective web servers, 246A, 246B, and 246C. User machines 242 may include web browsers 244 for accessing information to request reputation information from the reputation service.

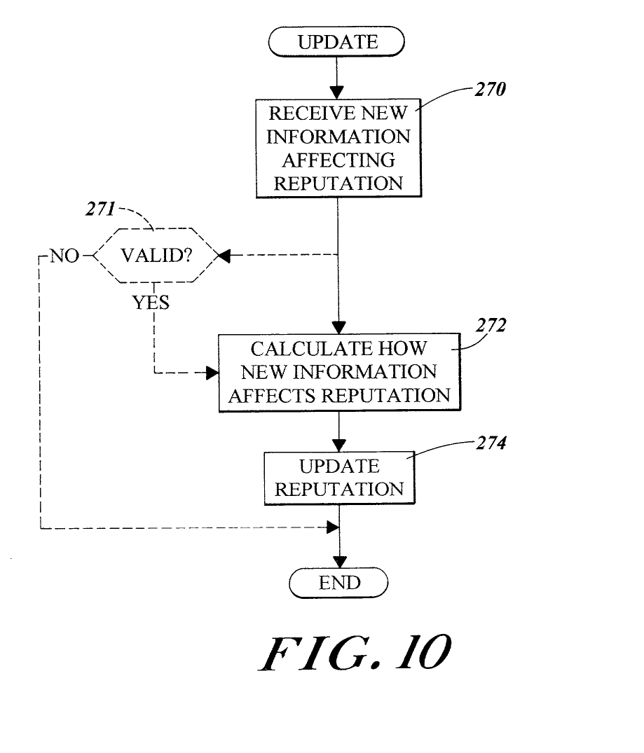

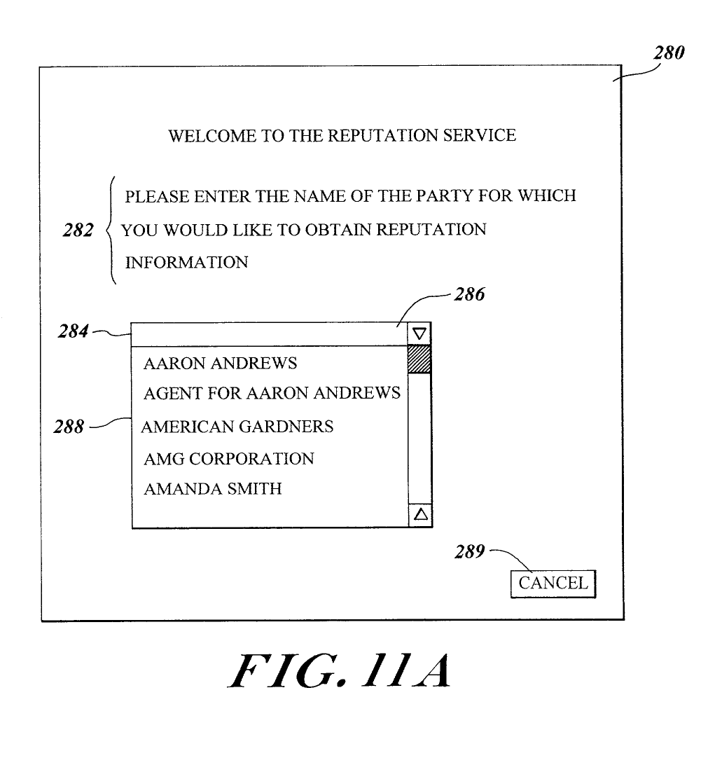

In order for the reputation information provided by the reputation service to retain value, the reputation information must be kept current. As such, the illustrative embodiment provides a facility for updating the information. FIG. 10 is a flowchart illustrating the steps that are performed to update reputation information. Initially, the reputation service 10 receives new information affecting the reputation of a party (Step 270 in FIG. 10). In some instances, there may be a need to validate that the information. One can envision instances where a party might provide erroneous information to either bolster or harm the reputation of a party. If the information is deemed to be valid, an algorithm may be applied to calculate how the new information effects the reputation of the party (step 272 in FIG. 10). One example of such an algorithm applies in the case where numerical values are assigned to a reputation (such as the 1-10 scale discussed in the example of FIG. 4B). In such a case, the new information provides a basis for calculating a numeric value for the reputation for the instance represented by the new information. The new information may then be added to the other data points representing other instances to calculate a new mean value that represents the reputation for the party. For example, suppose that the reputation service has data for the reputation of a party from three previous instances. In the three previous instances, the party was assigned reputation values of 5, 6 and 7. The reputation value is 6, representing the mean of the collected values. Suppose that new information for a fourth instance is received that assigns the party a reputation value of 10. The 10 value is added to the other values to produce a sum value of 28 (i.e., 5+6+7+10). The sum (28) is divided by the number of samples (i.e., 4) to produce a mean value of 7.

Once the calculation has been performed in step 272, the reputation value for the party is updated (step 274 in FIG. 10).

As has been mentioned above, the requester may be a person or an automated process. For example, the requester may be a web site that utilizes reputation information in a particular application. Similarly, the requester may be a program that is not a website that utilizes the requested information. Still further, the requester may be a person that requires user interfaced access and submit requests from the reputation service.

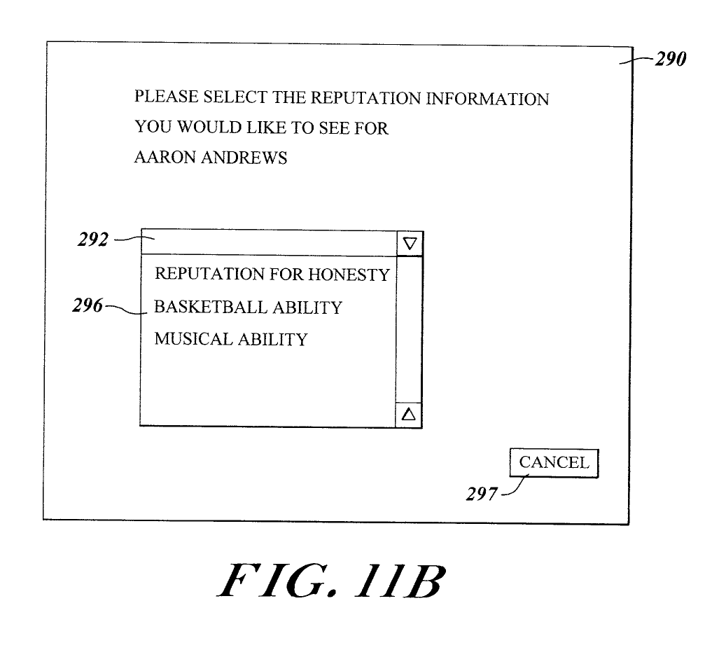

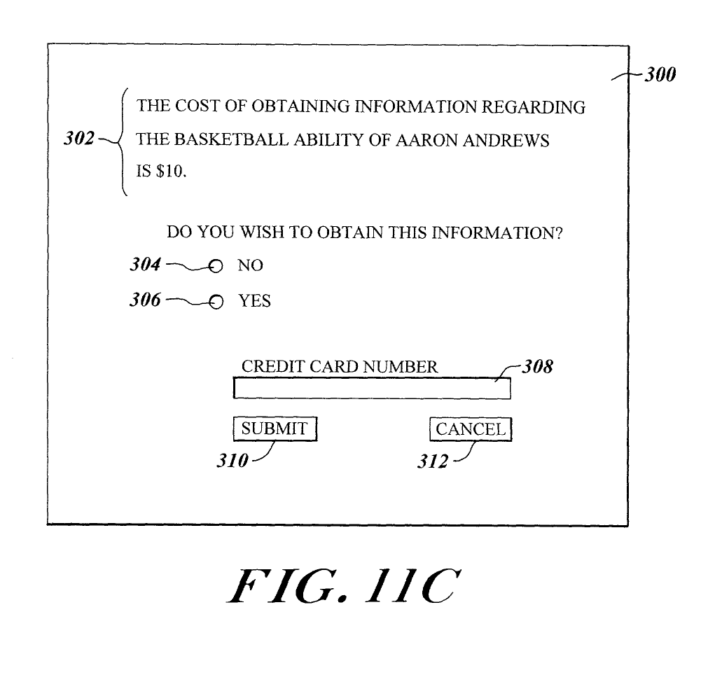

FIGS. 11A, 11B and 11C show an example where a website is provided for enabling users to obtain reputation information for parties. The webpage provides an interface that allows the users to request information. FIG. 11A shows an example of initial screen display 280 which welcomes a person to the reputation service. This initial display 280 includes textual information 282 asking the requestor to identify the party for which reputation information is sought. In the example depicted in FIG. 11A, the display 280 includes a list box 284 including a text box 286 in which the name of the party may be typed and a list 288 from which a name may be selected. A “cancel” button 289 allows the requester to terminate the process. Once the requestor has selected a party, a second display 290, as shown in FIG. 11B, may be displayed. A list box 292 sets forth reputation traits for which the reputation service has information on the selected party in a list 296. The example in FIG. 11B, presumes that the requestor has selected “Aaron Andrews” as the party for which information is sought. The requestor may then select to obtain information regarding the reputation of honesty, basketball ability or musical ability for Aaron Andrews. The second screen display 290 also includes a “cancel” button 297.

Suppose that the requestor selects basketball ability as the trait for which information is sought. FIG. 11C shows an example of a third display 300 that is then displayed to the requester. Textual information 302 identifies the cost of obtaining information regarding the basketball ability of Aaron Andrews. The requestor then may select the “no” option 304 to not obtain the information or the “yes” option 306 to obtain the information. If the requestor selects the “yes” option 306, the requestor is required to provide a credit card number 308. After the credit card number is entered, the requestor may choose the “submit” button 310 to obtain the requested information. If the requestor wishes to terminate the request session, the requestor may activate the “cancel” button 312.

While the present invention has been described with reference to an illustrative embodiment thereof, those skilled in the art will appreciate that various changes in form and detail may be made without departing from the intended scope of the present invention as defined in the appended claims.

1. A method, comprising the steps of:
providing an automated reputation service for furnishing information regarding reputations of parties relative to multiple traits; and
providing a first client with access to the reputation service via a communications network to furnish the information regarding a reputation of a selected party relative to the given trait.

2. The method of claim 1, wherein the method further comprises the step of providing a second client access to the reputation service to furnish information regarding the reputation of the selected party relative to the given trait.

3. The method of claim 1, wherein the method further comprises the step of providing the first client access to the reputation service to furnish information regarding a reputation of the selected party relative to an additional trait.

4. The method of claim 1, wherein the method further comprises the step of providing a second client access to the reputation service to furnish information regarding a reputation of an additional party relative to an additional trait.

5. The method of claim 1, wherein the first client is assessed a charge for providing the first client with access to the reputation service.

6. The method of claim 1, wherein the communications network is a computer network.

7. The method of claim 1, wherein the computer network is a wide area network (WAN).

8. The method of claim 1, wherein the computer network is the Internet.

9. The method of claim 1, wherein the communications network includes a wireless communications path.

10. The method of claim 1, wherein the selected party is a person.

11. The method of claim 1, wherein the selected party is an automated agent of a person.

12. A business method, comprising the steps of:
providing a collection of reputation data regarding at least one selected party;
furnishing at least a portion of the reputation data to a client; and
accepting remuneration for furnishing the portion of reputation data to the client.

13. The method of claim 12, wherein the remuneration is monetary remuneration.

14. The method of claim 12, wherein the client provides the remuneration on behalf of the client.

15. The method of claim 12, wherein a third party provides the remuneration on behalf of the client.

16. The method of claim 12, wherein the collection of reputation data holds reputation data for multiple parties.

17. The method of claim 12, wherein the selected party is a person.

18. The method of claim 12, wherein the selected party is an organization.

19. The method of claim 12, further comprising the steps of:
furnishing the portion of the reputation data to an additional client; and
accepting remuneration on behalf of the additional client for furnishing the portion of the reputation data to the additional client.

20. The method of claim 12, wherein the portion of the reputation data is furnished to the client via a computer network.

21. The method of claim 20, wherein the computer network is the Internet.

22. A system, comprising:
a collection of reputation data regarding multiple parties; and
an automated reputation service for accessing the collection of reputation data on behalf of clients to provide clients with data from the collection of reputation data.

23. The system of claim 22, wherein the automated reputation service accesses charges for accessing the collection of reputation data on behalf of the client.

24. The system of claim 22, wherein the automated service includes an interface for the clients to access the automated reputation services via a network.

25. The system of claim 22, wherein the interface enables clients to access the automated reputation service via the Internet.

26. The system of claim 22, wherein the collection of reputation data contains reputation data for multiple traits for as least one of the parties.
